(19) United States
(12) Patent Application Publication
(10) Pub. No.: US 2007/0230952 A1
(43) Pub. Date: Oct. 4, 2007

(54) Photosensitive material processor

(75) Inventors: Toshihiro Noguchi, Kanagawa (JP); Hideyuki Murakoshi, Kanagawa (JP)

Correspondence Address: TAIYO CORPORATION, 401 HOLLAND LANE, #407, ALEXANDRIA, VA, 22314, US

(73) Assignee: FUJIFILM CORPORATION

(21) Appl. No.: 11/591,508

(22) Filed: Nov. 2, 2006

(30) Foreign Application Priority Data
Nov. 30, 2005 (JP) 2005-346542

(51) Int. Cl. G03D 3/02

(52) U.S. Cl. 396/630

(57) ABSTRACT

The hoses connected to parts of a photosensitive material processor, like to a processing tank, are formed from a styrene containing or olefin containing thermoplastic elastomer. Plasticizers such as those found in PVC hoses are not used in the material so cracking does not occur in the portions connecting the hoses to the processing tanks. Further, since it is not necessary to make the connecting portions of the processing tanks out of metal in order to prevent cracking, the manufacturing costs of the processor can be reduced.

### CROSS-REFERENCE TO RELATED APPLICATION

This application claims priority under 35 USC 119 from Japanese Patent Application No. 2005-346542, the disclosure of which is incorporated by reference herein.

### BACKGROUND OF THE INVENTION

1. Field of the Invention

The present invention relates to a photosensitive material processor that processes development of a photosensitive material.

2. Description of the Related Art

Automated developers used in labs (e.g., film processors, printer processors, etc.) perform processing of photosensitive materials (e.g., film and color paper). The film and color paper are sequentially conveyed into multiple processing tanks filled with processing solution and water, whereby processing such as coloration development, bleach fixing, water washing and stabilizing are performed.

The component constitution of the processing solutions in each of the tanks and their amounts change with the processing of film and color paper. For this reason, fresh fluids and water are replenished to each processing tank from replenishing tanks in accordance with the amount of film and color paper being processed. These systems thus maintain the compositions and amounts of the fluids.

Mechanical strength and chemical resistance are demanded of the processing tanks, so these are formed from materials like resin that makes polyphenylene ether denaturalize (what is known hereafter as “denatured PPE”), resin that makes polyphenylene oxide denaturalize (what is known hereafter as “denatured PPO”), or styrene containing resins such as acrylonitrile butadiene styrene resins (hereafter, “ABS”).

The above-described denatured PPE and denatured PPO are substances where polyphenylene ether or polyphenylene oxide was denaturalized in order to raise the heat-resistance and strength of the parts. These belong to the group of thermoplastic resins, and they possess certain qualities such as being resistant to acids and alkali but weak against plasticizers and chlorinated hydrocarbon solvents.

Flexible polyvinyl chloride (hereafter, “PVC”) hoses that include plasticizers are used in photosensitive material processors in order to connect the processing tanks to the replenishing tanks. There are cases where, when residual stress or concentrated stress acts upon the nozzles of the processing tanks and replenishing tanks, cracks are generated in the nozzles due to what is known as solvent attack caused by the plasticizers in the hose.

For this reason, Japanese Patent Application (Laid-open) No. 2001-290251 recites the use of a material at the nozzle portions that is not affected by the plasticizer (e.g., metal), whereby damage to the nozzles due to the effects of plasticizers is prevented.

Nonetheless, when using these kinds of different materials to form the processing tanks, the manufacturing process becomes extremely complicated. As a result, manufacturing costs increase.

### SUMMARY OF THE INVENTION

In light of the above-described circumstances, the present invention provides a photosensitive material processor in which cracks do not occur even if a material that is vulnerable to plasticizers such as denatured PPE is used and further, with which manufacturing costs for the processor can be kept down.

The first embodiment of the present invention is a photosensitive material processor, wherein hoses, in which processing solution flows for use and for waste in the course of development processing a photosensitive material, are formed from a resin in which a polyolefin containing additive has been added to a styrene containing or olefin containing thermoplastic elastomer.

The denatured PPE and denatured PPO or ABS, which are the materials from which the processing tank and the replenishing tank of the photosensitive material processor are formed, have certain qualities. Namely, they are strong against substances like acid and alkali but weak against the plasticizers and chlorinated hydrocarbon solvents used in PVC. For this reason, when, for example, a PVC hose is connected to the connecting portion of a processing tank, there may be a danger of cracking occurring in the connecting portion of the processing tank due to the plasticizer in the PVC.

With the above-described embodiment, the hoses are formed from a resin in which a polyolefin containing additive has been added to a styrene containing or olefin containing thermoplastic elastomer, and this is designed so that plasticizers that adversely affect the connecting portion of the processing tank are not used.

Due to this, the generation of cracking in the connecting portion is prevented. Accordingly, it is not necessary to make the connecting portion out of metal in order to prevent cracking in the connecting portion of the processing tank so manufacturing costs can be reduced.

Further, with regard to PVC, movements are proceeding to get away from the use of lead. Nonetheless, there are concerns regarding the effects of the plasticizers or phthalic acid esters, which are used when processing PVC, namely with regard to the way they affect the human body. For this reason, hoses are made from a styrene containing or olefin containing thermoplastic elastomer instead of PVC, whereby progress in the reduction of PVC can be enhanced.

When forming the hose with only a styrene containing thermoplastic elastomer, the hose becomes too soft and the sealability necessary in a hose cannot be ensured. For this reason, the material quality can be ensured by adding a polyolefin containing additive.

In the above-described embodiment, the polyolefin containing additive can also be a homopolymer.

The mechanical properties of the material can be made to improve when using a forming material made from a homopolymer, when compared to a case where a copolymer is used.

In the above-described embodiment, the resin can be made to have a composition where the polyolefin containing additive is at 15-30 parts by mass to 100 parts by mass of the styrene containing or olefin containing thermoplastic elastomer.

Further, in the above-described embodiment, the composition can be made so that the polyolefin containing additive is at 20-30 parts by mass to 100 parts by mass of the styrene containing or olefin containing thermoplastic elastomer.

Furthermore, in the above-described embodiment, the composition can be made so that the polyolefin containing additive is at 25 parts by mass to 100 parts by mass of the styrene containing or olefin containing thermoplastic elastomer.

Due to each of the above embodiments, good hardness can be achieved in the formed hose and the seal between the connecting portion of the processing tank and the hose is also good.

In the above-described embodiment, the connecting portion can be formed from at least an amorphous resin.

By forming the connecting portion from at least an amorphous resin, dimensional stability and chemical resistance (to acids, alkali, etc.) can be obtained in that area.

In the above-described embodiment, the amorphous resin can be denatured polyphenylene ether, denatured polyphenylene oxide or a styrene containing resin.

In the above-described embodiment, the connecting portion can be provided in at least a processing tank in which processing solution that processes the photosensitive material is accumulated, a replenishing tank that replenishes processing solution to the processing tank, and a waste fluid tank to which waste fluid from the processing tank is discharged.

The photosensitive material processor of the present invention is configured as described above so cracking in the connecting portion can be prevented. Further, it is not necessary to make the connecting portion out of metal so manufacturing costs can be reduced.

### BRIEF DESCRIPTION OF THE DRAWINGS

Embodiments of the present invention will be described in detail based on the following figures, wherein:

FIG. 1 is an outline structural drawing of a printer processor provided with a photosensitive material processor according to an embodiment of the present invention;

FIG. 2 is an explanatory diagram showing a circulation system of the development processing unit of the printer processor according to an embodiment of the present invention; and

FIG. 3 is an explanatory diagram showing a replenishing system of the development processing unit of the printer processor according to an embodiment of the present invention.

### DETAILED DESCRIPTION OF THE INVENTION

Hereafter, the photosensitive material processor according to an embodiment of the present invention will be explained.

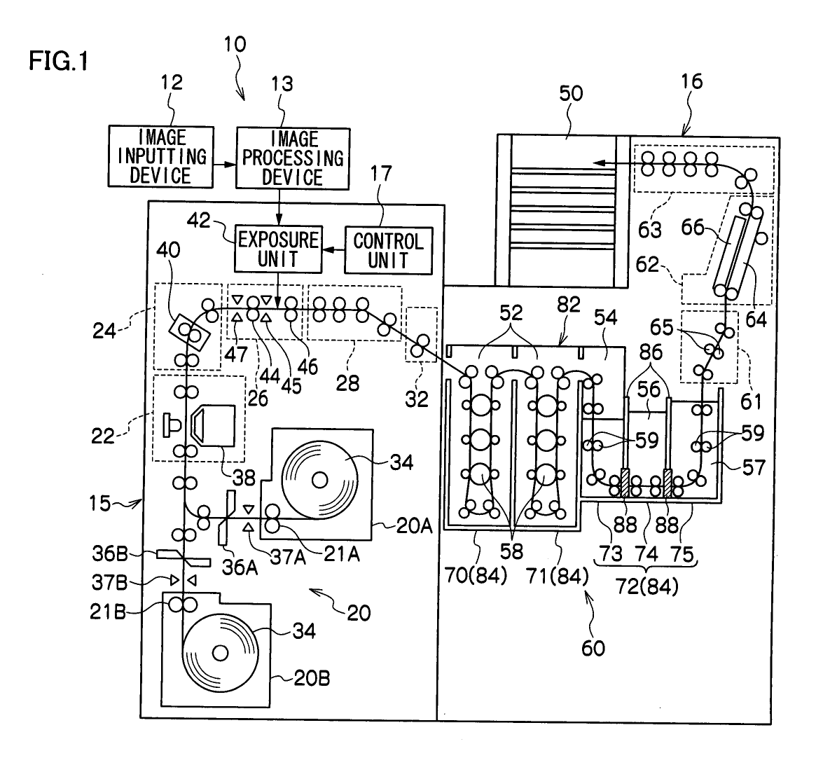

In FIG. 1, a printer processor 10 provided with a stable tank 72 is shown as a photosensitive material processor. This printer processor 10 is provided with an image inputting device 12, an image processor 13, a printer 15 and a processor 16. Each portion that comprises the printer processor 10 is connected to a control unit 17 via wiring not shown in the drawings, and the overall operation of the printer processor 10 is controlled by the control unit 17.

The image inputting device 12 uses an imaging device such as a CCD image sensor to photoelectrically scan the projection of an image recorded on photographic film, thereby generating image data. Or, image data is obtained by reading out image data recorded to a recording medium such as a memory card. This image data is sent to the image processor 13 where image processing such as color balance correction and density correction are performed. Then, the image data for which image processing was performed is sent to the printer 15.

The printer 15 is a device that performs image recording with recording light whose intensity has been modulated based on the image data, while conveying a cut recording paper 14 that is cut to a preset length. The printer 15 is provided with, from the upstream side of the conveying direction, a supply unit 20, a rear side printer 22, a resist unit 24, an image recording unit 26, a sub-scanning receiver 28 and a discharging unit 32. At each position, multiple pairs of conveying rollers comprising drive rollers and nip rollers are provided along the conveying route of the cut recording paper 14, which is conveyed along the conveying route.

Magazines 20A, 20B, in which are stored long photosensitive recording paper 34 (that arrived rolled up), are set in the supply unit 20. With the present embodiment, two magazines 20A, 20B are provided, however, there can also be one magazine or three or more as well.

A joined portion (omitted from drawings) that joins the ends of belt-shaped recording paper to each other is provided in the photosensitive recording paper 34 stored in these magazines 20A, 20B. This is in order to do away with losses of the photosensitive recording paper 34 during the manufacturing process.

Cutters 36A, 36B are respectively provided at the exits of the magazines 20A, 20B in order to cut the photosensitive recording paper 34. The cutters 36A, 36B receive a control signal from the control unit 17, then drive and cut the sent out photosensitive recording paper 34 at only a preset length in accordance with the print size, thereby forming a cut recording paper.

There are several standard print sizes, e.g., L (89×127), panorama (89×254), 2L (127×178), 8-cut (165×216), 6-cut (203×254), 4-cut (254×305) and the like. In the present embodiment, the width in the direction perpendicular to the conveying direction corresponds to the cut recording paper sizes of 89, 95, 102, 117, 120, 127, 130, 152, 165, 178, 203, 210, 216, 254 and 305. Note that the unit of measurement for all of these sizes is in millimeters.

Splice sensors 37A, 37B that detect a splice hole 81 provided in the photosensitive recording paper 34 and output a signal to the control unit 17 are respectively provided upstream of the cutters 36A, 36B. When the splice sensors 37A, 37B output the signal, the control unit 17 drives the cutters 36A, 36B after sending out the photosensitive recording paper 34 of a preset length.

When the cut recording paper has the joined portion included thereon, it is discharged as is to a sorter 50 without undergoing reverse side printing or image recording. Note that although guillotine-type cutters are used in the present embodiment, the cutters are not thus limited. Conventionally known device such as a rotary cutter that uses rotational blades can also be employed.

The rear side printer 22 is provided with a rear side printing head 38 that records printing information like the date of photographing, the day it was printed, frame number and various identifying information on the non-recording surface of the cut recording paper (i.e., on the side opposite the side that is exposed). For the rear side printing head 38, any known print head such as a dot impact head, inkjet head and thermal transfer print head can be used, as long as it exhibits resilience to the printed information to wet-type developing performed later on.

Further, the resist unit 24 comprises a pair of resist rollers 40 that adjusts the inclination and positioning of the cut recording paper in the widthwise direction, as well as multiple pairs of conveying rollers arranged before and after this pair of resist rollers 40. The resist unit 24 comprises these components in order to prevent skewing of the exposure position and angle with respect to the cut recording paper in the image recording unit 26. Regarding the method for adjusting inclination and positioning in the widthwise direction with the pair of resist rollers 40, a well-known method can be used such as tilt resist, top resist, side resist and the like.

Further, the image recording unit 26 consists of an exposure unit 42, a pair of sub-scanning rollers 44, 46, and a recording paper sensor 45 that detects passage of the cut recording paper, and operation control is performed by the control unit 17.

The exposure unit 42 is connected to the image processor 13. When the recording paper sensor 45 has detected that the leading edge of the cut recording paper has passed by, the exposure unit 42 scans light beams LB of intensity-modulated red, green and blue light in the main scanning direction (i.e., the direction perpendicular to the direction of conveyance) based on image data, and records the image to the cut recording paper.

The pairs of sub-scanning rollers 44, 46 are arranged at the upstream side and the downstream side of the direction of conveyance such that they sandwich the exposure position with the light beams LB. The pairs of sub-scanning rollers 44, 46 convey the cut recording paper at a preset speed in the sub-scanning direction (i.e., the direction parallel to the direction of conveyance).

Note that the nip rollers of the pairs of sub-scanning rollers 44, 46 are designed to be switchable between a position that clasps the cut recording paper and a position removed from the cut recording paper, and these can be switched when the leading edge or rear edge of the cut recording paper has been detected by a position sensor 47. Due to this configuration, the leading edge of the cut recording paper hits against the pair of sub-scanning rollers 46 of the downstream side and the rear edge moves away from the pair of sub-scanning rollers 44 of the upstream side, whereby the imparting of excessive impact to the cut recording paper is prevented.

Meanwhile, the sub-scanning receiver 28 is provided with multiple pairs of rollers that retain the leading edge of the cut recording paper sent out from the image recording unit 26 during image recording. The cut recording paper is sent out towards the downstream side at a speed that is the same as the conveying speed with the image recording unit 26. Each of the pairs of rollers of the sub-scanning receiver 28 comprise drive rollers and nip-releasable nip rollers and these clasp and retain the cut recording paper after the leading edge of the cut recording paper has passed between them by during image recording. Due to this, fluctuations in conveying speed are prevented. The speed fluctuations are caused by collision of the leading edge of the cut recording paper to the rollers.

Also, the discharging unit 32 conveys the cut recording paper sent from the sub-scanning receiver 28 and sends it to the processor 16 at a speed corresponding to the processing speed of the processor 16.

The processor 16 comprises a developing processor 60, a squeeze unit 61, a drying processor 62, a discharging unit 63 and the sorter 50. A development processing tank 82 is provided at the developing processor 60. From the upstream side of the conveying direction, a coloration development tank 70, a bleach fixing tank 71 and a stable tank 72, which comprises a first stable tank 73, a second stable tank 74 and a third stable tank 75, are all provided in this order in a state where they are all divided off.

A preset amount of processing solutions is stored in each of the coloration development tank 70, the bleach fixing tank 71, and in the first stable tank 73 to the third stable tank 75, namely, a color developer in the coloration development tank 70, bleaching fixer in the bleach fixing tank 71, and stable processing solutions in the first stable tank 73 to the third stable tank 75. The cut recording paper is conveyed inside each processing tank by multiple conveying rollers 58 and nip rollers 59 distributed inside the conveying racks 52, 54, 56 and 57, which are respectively provided at the coloration development tank 70, the bleach fixing tank 71, and the first stable tank 73 to the third stable tank 75, whereby processing for development, fixing and stabilization are performed.

Also, the squeeze unit 61 is arranged above the third stable tank 75 and, although not shown in the drawings, comprises blades, an air-blasting duct and conveying rolls. The blades come in contact with both surfaces of the cut recording paper conveyed by the conveying rolls and scrape the processing solution off the cut recording paper, and the air-blasting duct faces the cut recording paper, blows out air and blows the processing solution off the cut recording paper.

The drying processor 62 is arranged above the squeeze unit 61 and comprises a conveying belt 64 and a fan duct 66. The fan duct 66 faces the conveying belt 64 and blows out drying air heated with a heater, and pushes the cut recording paper towards the conveying belt 64 side. The cut recording paper is made to pass in front of the fan duct 66 in this state, whereby processing solutions adhered to the cut recording paper are completely removed. Then the cut recording paper, having passed through the drying processor 62, is sent to the sorter 50 by the discharging unit 63.

Next, the developing processor 60 will be explained in detail.

The development processing tank 82 shown in FIG. 1 is provided with the coloration development tank 70, the bleach fixing tank 71, and the first stable tank 73, second stable tank 74 and third stable tank 75 (which, in order to facilitate explanation, may be explained hereafter such that these processing tanks are simply referred to as “the processing tank 84”), and these are provided in a state where they are each separated. Each of the nip rollers 59 are respectively arranged inside the processing tank 84, and these clasp and convey the cut recording paper.

Here, dividers 86 are provided each between the first stable tank 73 and second stable tank 74 as well as the second stable tank 74 and third stable tank 75 (refer to FIG. 1). Photosensitive material route components 88 are provided at each divider 86, and these allow passage of the cut recording paper while preventing leakage of the processing solutions.

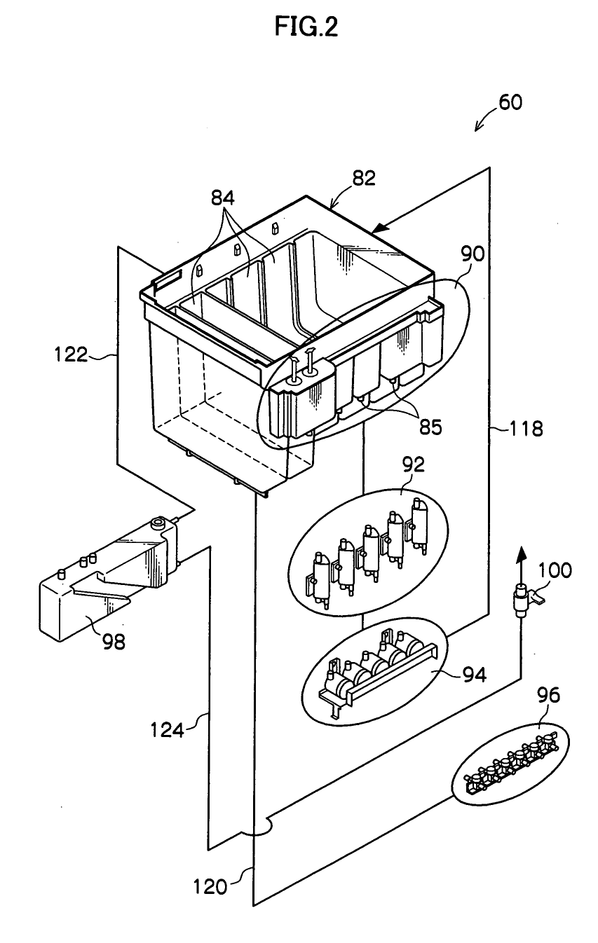

It should be noted that, as shown in FIG. 2, a sub-tank 90 is respectively provided for each of the processing tanks 84, and this is designed so that the processing solutions inside the processing tanks 84 flow into the interior of each sub-tank 90. A heater 92 is arranged in each sub-tank 90 and on/off control of this heater 92 is performed with a thermo switch (not shown) and is designed to maintain the temperature of the processing solutions in the processing tanks 84 within a preset range. The temperature of the processing solution in the sub-tank 90 is adjusted with this heater 92.

A circulation pump 94 is connected to the sub-tank 90. The processing solution inside the sub-tank 90 can be returned to each processing tank 84 via a hose 118 connected to each processing tank 84. Due to this configuration, the processing solution inside each processing tank 84 can be maintained at a constant temperature. Also, when running the printer processor 10, the temperatures of each of the processing solutions can be raised to a preset temperature.

Drain outlets (omitted from drawings) are also provided at each of the processing tanks 84. One end of a hose 120 is connected to the drain outlet and a drain valve 96 is connected to the other end of the hose 120. When draining the processing solution accumulated in the processing tank 84 for maintenance and the like, this drain valve 96 is opened and the processing solution of the processing tank 84 is drained out via the hose 120.

A waste fluid tank 98 is provided at the development processing tank 82. The waste fluid tank 98 is connected to each processing tank 84 via a hose 122. When the processing solution reaches above a preset height due to replenishment of the processing solution and the like, it overflows from the processing tank 84 and gathers inside the waste fluid tank 98. Then when the waste solution in the waste fluid tank 98 reaches over a preset amount, a waste fluid valve 100 connected to the waste fluid tank 98 opens and the waste solution in the waste fluid tank 98 is drained out via a hose 124 (waste solution hose).

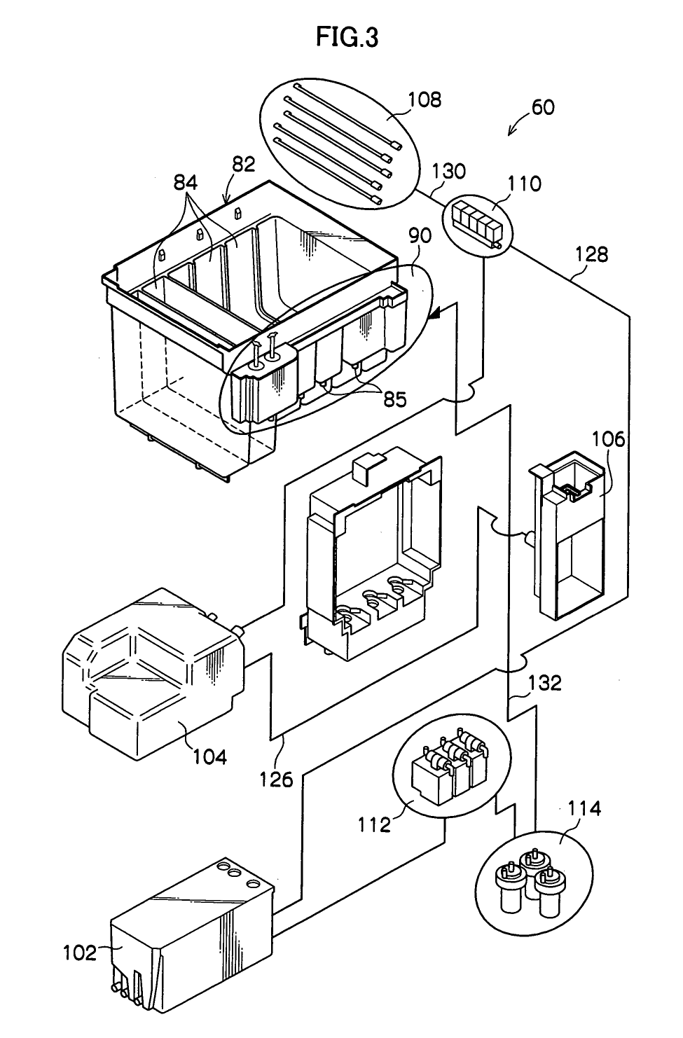

Also, as shown in FIG. 3, a replenishing tank 102 is provided at the development processing tank 82 and the interior of the replenishing tank 102 is divided into three layers. Due to this, the degree of dilution of the processing solution inside the replenishing tank 102 can be adjusted whereby the processing solution can be made.

Further, a water tank 104 is provided at the development processing tank 82 and water accumulated once is supplied to the water tank 104 with a hopper 106 connected thereto via a hose 126. Then the water in the water tank 104 is used when diluting the processing solution inside the replenishing tank 102 or when washing the conveying racks 52, 54, 56 and 57 (refer to FIG. 1) with a wash nozzle 108.

For this reason, the water tank 104 is connected to the replenishing tank 102 or wash nozzle 108 with a hose 128 (replenishing hose) or a hose 130, and can be switched with a solenoid valve 110.

A replenishing pump 112 is also connected to the replenishing tank 102. Water percolated through a filter 114 is supplied to the interior of the sub-tank 90 via a hose 132.

It should be noted that the processing tanks 84 and solenoid valve 110 are formed from resins such as a denatured PPO resin or a denatured PPE resin. Examples of materials that can be used for the denatured PPO include Noryl produced by GE Plastics Japan, and for the denatured PPE, Zylon produced by Asahi Kasei Construction, and lupiace produced by Mitsubishi Gas and Chemicals. These materials exhibit excellent chemical resistance to processing solutions (e.g., developing solutions, fixers, and bleaching fixers) and are suitable for injection molding.

Further, ABS is used in the hopper 106 and replenishing tank 102. ABS has chemical resistance to processing solutions and its formation with injection molding is good. There is little surface sinking at the time of formation and a good flat surface can be formed.

Polyethylene (hereafter, “PE”), polypropylene (hereafter, “PP”) and high-density polyethylene (“HDPE”), which are olefin containing resins, are used in components such as the water tank 104 and waste fluid tank 98. Not only do these exhibit high chemical resistance to processing solutions, but the materials are also cheap and large tanks can be easily produced with hollow formation, so these can be preferably used in areas that do not require highly precise dimensions.

Here, the denatured PPE and denatured PPO used in the processing tanks 84 have certain qualities, namely, they are strong against substances like acid and alkali but weak against plasticizers and chlorinated hydrocarbon solvents. For this reason, in the case where a material including a plasticizer or PVC and the like is used for a hose connecting the processing tanks 84, cracks tend to be generated in a connecting portion 85 of the processing tanks 84 once residual stress or concentrated stress act upon the connecting portions 85, and this is due to solvent attack. (Note that here, only the connecting portions 85 of the processing tanks 84 are shown.)

For this reason, with the present embodiment, at least components connected to the processing tank 84 such as the hoses 118, 120, 122 and 132 are formed from a resin where a polyolefin containing additive has been added to a styrene containing or olefin containing thermoplastic elastomer. (Note that here, only some of the hoses connected to the processing tanks 84 were listed but in actual practice, other hoses are used as well.) That is, since plasticizers used in PVC are not included in the resin, the device can be made so that cracking does not occur in the connecting portions 85 connected to parts such as the hoses 118, 120, 122 and 132.

Due to this configuration, it is not necessary to make the connecting portions 85 connected to parts like the hoses 118, 120, 122 and 132 out of metal so costs can be reduced. Here, a homopolymer is used for the polyolefin containing additive, whereby the mechanical qualities of the resin can be made to improve compared to when a copolymer is used.

With the present embodiment, an example of the styrene containing or olefin containing thermoplastic elastomer to which a polyolefin containing additive was added is Tuftec H1221 (a hydrogenated styrene containing thermoplastic elastomer) manufactured by Asahi Kasei Construction. This Tuftec H1221 is a material in which PP, PE and the like have been blended as additives to Tuftec. When forming with Tuftec only, the material becomes too soft, has little restoring force and the sealing qualities are not good. For this reason, by adding PP and the like as additives to the Tuftec, the desired hardness can be obtained.

Here, when the composition ratio of Tuftec to PP is 100:10 (i.e., PP at 10% mass relative to Tuftec at 100), the hose is too soft and limp and even when connected to the connecting portion 85, it comes off immediately and good sealability cannot be obtained. Also, at 100:50, the hose is too hard, has bad bending qualities and it is difficult to make it connect to the connecting portion 85.

However, when the composition ratio of Tuftec to PP (percentage mass, the same hereafter) is at 100:15, 100:20, 100:25 and 100:30 a good hardness can be obtained with any of these composition ratios. Further, the hose can be connected to the connecting portion 85 and sealing qualities are also good and, when compared to a flexible polyvinyl chloride hose, remarkably there is no performance deterioration.

Specifically, each of the hoses (inner diameter (φ 12 mm, outer diameter (φ 17 mm) were formed with a Tuftec to PP composition ratio of 100:20, 100:25 and 100:30. A pressure resistance test (regular pressure: 0.1 MPa×24 hrs.; high pressure: 0.25 MPa×1 hr.); high temperature resistance test (80° C.×24 hrs.); and low temperature resistance test (−25° C.×24 hrs.) were performed in a state where the hose was connected to the connecting portion 85 of the processing tank 84. No fluid leaks or hose deformation and the like were observed.

However, when the composition ratio of Tuftec to PP was 100:15, there are cases where the capability to resist pressure at the high-pressure portion (0.25 MPa) is not so good when compared to other ratios.

For this reason, it is preferable that the composition ratio of Tuftec to PP be 100:20, 100:25 or 100:30, i.e., in the range of 100:20-30. A composition ratio of Tuftec to PP of 100:25 is recommended since it is the central value in a composition ratio region that exhibits no problems as well as a total balance of capabilities.

Here, when a hose is formed with the Tuftec to PP composition ratio at 100:20-30, heat can be applied to the hose, which can then be made to have a curved shape and further, the diameter of the hose can be widened. For this reason, designing pipe distribution broadens. Also, since insert formation also becomes possible, branched piping can be formed uniformly and this does away with necessity to connect the hose to the branched piping so assembly work is reduced. As a result, manufacturing costs of the processor are lowered.

Further, with regard to PVC, movements are proceeding to get away from the use of lead. Nonetheless, the effects of the plasticizers or phthalic acid esters, which are used when processing PVC, with regard to the human body has been concerned. For this reason, the hose is formed from a styrene containing or olefin-type thermoplastic elastomer, whereby progress in the reduction of PVC can be enhanced.

Here, besides Tuftec H1221, which is a styrene containing thermoplastic elastomer, a different material such as an olefin containing thermoplastic elastomer can be used for the material from which the hose is formed. For example, Santoprene made by AES Japan, Ltd. can be used, however, transparency cannot be obtained. For this reason, it is preferable to use styrene containing thermoplastic elastomers in areas that require transparency.

Also, insert formation cannot be performed with Santoprene so when using branched pipes, the operation of attaching the branched pipes to the hose becomes necessary so, compared to when Tuftec is used, operating efficiency is not good.

Note that with the present embodiment, an example is raised where parts such as the hoses 118, 120, 122 and 132 attached to the processing tanks 84 are formed from Tuftec H1221. Nonetheless, the components formed from Tuftec H1221 are not limited only to the connecting hoses applied to components made from denatured PPO and denatured PPE. the connecting hoses applied to parts like the hopper 106 and replenishing tank 102, and the components formed from ABS can also be formed from Tuftec H1221. Further, in light of environmental problems, all of the hoses used with the processing tanks 84 can be formed from Tuftec H1221.

What is claimed is:

1. A photosensitive material processor, wherein hoses, in which processing solution flows for use and for waste in the course of development processing a photosensitive material, are formed from a resin in which a polyolefin containing additive has been added to a styrene containing or olefin containing thermoplastic elastomer.

2. The photosensitive material processor of claim 1, wherein the polyolefin containing additive is a homopolymer.

3. The photosensitive material processor of claim 1, wherein the resin has a composition where the polyolefin containing additive is at 15-30 parts by mass to 100 parts by mass of the styrene containing or olefin containing thermoplastic elastomer.

4. The photosensitive material processor of claim 1, wherein the resin has a composition where the polyolefin containing additive is at 20-30 parts by mass to 100 parts by mass of the styrene containing or olefin containing thermoplastic elastomer.

5. The photosensitive material processor of claim 1, wherein the resin has a composition where the polyolefin containing additive is at 25 parts by mass to 100 parts by mass of the styrene containing or olefin containing thermoplastic elastomer.

6. The photosensitive material processor of claim 1, wherein a connecting portion of the photosensitive material processor to which the hose is connected is formed from an amorphous resin.

7. The photosensitive material processor of claim 6, wherein the amorphous resin is a denatured polyphenylene ether, denatured polyphenylene oxide or styrene containing resin.

8. The photosensitive material processor of claim 6, wherein the connecting portion is provided in at least a processing tank in which processing solution that processes the photosensitive material is accumulated, a replenishing tank that replenishes processing solution to the processing tank, and a waste fluid tank to which waste fluid from the processing tank is discharged.

9. A photosensitive material processor comprising:
a processing tank in which processing solution that processes a photosensitive material is accumulated;
a replenishing tank that replenishes processing solution to the processing tank;
a waste fluid tank to which waste fluid from the processing tank is discharged;
hoses that connect the processing tank to the replenishing tank and the processing tank to the waste fluid tank; and
connecting portions for connecting the hoses to each of the processing tank, the replenishing tank and the waste fluid tank, wherein
the hoses are formed from a resin where a polyolefin containing additive has been added to a styrene containing or olefin containing thermoplastic elastomer.

10. The photosensitive material processor of claim 9, wherein the polyolefin containing additive is a homopolymer.

11. The photosensitive material processor of claim 9, wherein at least the connecting portions are formed from an amorphous resin.

12. The photosensitive material processor of claim 11, wherein the amorphous resin is a denatured polyphenylene ether, denatured polyphenylene oxide or styrene containing resin.
